(19) United States
(12) Patent Application Publication
(10) Pub. No.: US 2005/0180464 A1
(43) Pub. Date: Aug. 18, 2005

(54) Audio communication with a computer

(75) Inventors: Christopher Frank McConnell, Berwyn, PA (US); Thomas A. Pleatman, Media, PA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Adondo Corporation, Wayne, PA (US)

(21) Appl. No.: 11/048,948

(22) Filed: Feb. 2, 2005

Related U.S. Application Data
(63) Continuation-in-part of application No. PCT/US03/31193, filed on Oct. 1, 2003.
(60) Provisional application No. 60/415,311, filed on Oct. 1, 2002.
(60) Provisional application No. 60/457,732, filed on Mar. 25, 2003.
(60) Provisional application No. 60/541,487, filed on Feb. 3, 2004.

(51) Int. Cl. H04J 1/02

(52) U.S. Cl. 370/494

(57) ABSTRACT

In one embodiment, a first communications channel with a user is established and an audio user request to establish a second communications channel to enable communications with a party is received. The audio user request is recognized, and the second communications channel is established. In another embodiment, a communications channel between a computer and a user communications device is established, and a user input having an audio request is detected and stored. A user profile is accessed and a first grammar is selected based on the user profile. An attempt is made to recognize the audio request using the first, active grammar. If the audio request is not recognized, the first grammar is deactivated, a second grammar is activated and an attempt is made to recognize the audio request using the second grammar.

This application is a continuation-in-part of PCT Application No. PCT/US03/31193, filed Oct. 1, 2003, titled “A System and Method for Wireless Audio Communication with a Computer,” which in turn claims the benefit of provisional U.S. patent application Ser. No. 60/415,311, filed Oct. 1, 2002, titled “A System and Method for Wireless Audio Communication with a Computer;” and provisional U.S. patent application Ser. No. 60/457,732, filed Mar. 25, 2003, also titled “A System and Method for Wireless Audio Communication with a Computer.” Furthermore, this application claims benefit under 35 U.S.C. §119(e) of provisional U.S. patent application Ser. No. 60/541,487, filed Feb. 3, 2004, titled “A System and Method for Wireless Audio Communication with a Computer; Continuation Describing the Use of Multiple Hardware Configurations with one Computer, Multiple Users, and telephone Bridging.” The disclosures of the above-identified documents are hereby incorporated by reference as if set forth fully herein.

### FIELD OF THE INVENTION

The present invention relates to voice recognition systems and methods for receiving audio input and using such audio input to interact with a computer application. In particular, the present invention relates to such voice recognition systems and methods that can be used in connection with—and can switch between—multiple hardware configurations. More particularly, the present invention relates to such voice recognition systems and methods that selectively use limited voice recognition vocabularies to optimize voice recognition results. Even more particularly, the present invention relates to such voice recognition systems and methods for connecting and transferring telephone calls over a variety of communications channels.

### BACKGROUND OF THE INVENTION

The public is increasingly using computers to store and access information that affects their daily lives. Personal information such as appointments, tasks and contacts, as well as enterprise data such as data in spreadsheets, databases, word processing documents and the like are all types of information that are particularly amenable to storage in a computer because of the ease of updating, organizing, and accessing such information. In addition, computers are able to remotely access time-sensitive information, such as stock quotes, weather reports and so forth, on or near a real-time basis from the Internet or another network. To perform all of the tasks required of them, computers have become quite sophisticated and computationally powerful. In addition, computers have become more versatile in the manner in which they can be implemented. For example, a highly advanced automobile may be equipped with an on-board computer, or a computer may be embedded within another device, such as a consumer product, so as to enable the product to have enhanced functionality that is beyond the capabilities of a typical device. Thus, while a user has access to his or her computer—in other words, while the user is at home or at the office (or possibly in a highly advanced automobile)—the user is able to easily access such computational power to perform a desired task.

In many situations, however, a user will require access to such information while traveling or while simply away from his or her computer. Unfortunately, the full computing power of a computer is, for the most part (and except in the case of the highly advanced automobile), immobile. For example, a desktop computer is designed to be placed at a fixed location, and is, therefore, unsuitable for mobile applications. Similarly, a consumer product with an embedded computer would be immobile in most cases. Laptop computers are much more transportable than desktop computers, and have comparable computing power, but are costly and still fairly cumbersome. In addition, long range wireless Internet connectivity (wireless WAN or wide area network) is expensive and still not widely available, and a cellular telephone connection for such a laptop is slow by current Internet standards. In addition, having remote Internet connectivity is duplicative of the Internet connectivity a user may have at his or her home or office, with an attendant duplication of costs.

Conventionally, a personal digital assistant (“PDA”) can be used to access a user's information. Such a PDA can connect intermittently with a computer through a cradle or IR beam and thereby upload or download information with the computer. Some PDAs can access the information through a wireless connection, or may double as a cellular telephone. However, PDAs have numerous shortcomings. For example, PDAs are expensive, often duplicate some of the computing power that already exists in the user's computer, sometimes require a subscription to an expensive service, often require synchronization with a base station or personal computer, are difficult to use—both in terms of learning to use a PDA and in terms of a PDA's small screen and input devices requiring two-handed use—and have limited functionality as compared to a user's computer. As the amount of mobile computing power is increased, the expense and complexity of PDAs increases as well. In addition, because a conventional PDA stores the user's information on-board, a PDA carries with it the risk of data loss through theft or loss of the PDA.

As the size, cost and portability of cellular telephones has improved, the use of cellular telephones has become almost universal. Some conventional cellular telephones have limited voice activation capability to perform simple tasks using audio commands such as calling the telephone of a specified person (the number is stored in the cellular phone). Similarly, some automobiles and advanced cellular telephones can recognize sounds in the context of receiving simple commands. In such conventional systems, the software involved simply identifies a known command (i.e., sound) which causes the desired function to be performed, such as calling a desired person. In other words, a conventional system matches a sound to a desired function, without determining the meaning of the word(s) spoken.

Similarly, conventional software applications exist that permit an email message to be spoken to a user by way of a cellular telephone. In such an application, the cellular telephone simply relays a command to the software, which then plays the message. Conventional software that is capable of recognizing speech is either server-based or primarily intended for a user that is co-located with the computer. For example, voice recognition systems for call centers need to be run on powerful servers due to the systems' large size and complexity. Such systems are large and complex in part because they need to be able to recognize speech from speakers having a variety of accents and speech patterns. Such systems, despite their complex nature, are still typically limited to menu-driven responses. In other words, a caller to a typical voice recognition software package must proceed through one or more layers of a menu to get to the desired functions, rather than being able to simply speak the desired request and have the system recognize the request. Conventional methods for improving such software's ability to recognize diverse commands typically involve providing a large speech vocabulary for the software to attempt to match to a spoken command. Using a large vocabulary, however, again requires a powerful computing device because of the many comparisons that would need to be made in order to match a sound, word or phrase in the large vocabulary to a spoken command. Conventional voice recognition software that is designed to run on a personal computer is primarily directed to dictation, and such software is further limited to being used while the user is in front of the computer and to accessing simple menu items that are determined by the software. Thus, conventional voice recognition software merely serves to act as a replacement for or a supplement to typical input devices, such as a keyboard or mouse.

Furthermore, conventional PDAs, cellular telephones and laptop computers have the shortcoming that each is largely unable to perform the other's functions. Advanced wireless devices combine the functionality of PDAs and cellular telephones, but are very expensive. Thus, a user either has to purchase a device capable of performing the functions of a PDA, cellular telephone, and possibly even a laptop—at great expense—or the user will more likely purchase an individual cellular telephone, a PDA, and/or a laptop.

Accordingly, what is needed is a portable means for communicating with a computer, regardless of the type (or implementation) of the computer and the location of its user. More particularly, what is needed is a system and method for verbally communicating with a computer to obtain information by way of an inexpensive, portable device. Furthermore, it would be advantageous to have enhanced voice recognition in such a system and method. In addition, it would be desirable for such a system and method to be able to connect two or more parties on a telephone call by way of any communication channel.

### SUMMARY OF THE INVENTION

In view of the foregoing drawbacks and shortcomings, a method, system and computer-readable medium are disclosed herein for enabling communication with a computer. In one embodiment, a first communications channel with a user is established and an audio user request to establish a second communications channel to enable communications with a party is received. The audio user request is recognized, and the second communications channel is established.

In another embodiment, a communications channel between a computer and a user communications device is established. A user input having an audio request is detected and stored. A user profile is accessed and a first grammar is selected based on the user profile. An attempt is made to recognize the audio request using the first, active grammar. If the audio request is not recognized, the first grammar is deactivated, a second grammar is activated and an attempt is made to recognize the audio request using the second grammar.

### BRIEF DESCRIPTION OF THE DRAWINGS

The foregoing summary, as well as the following detailed description of preferred embodiments, is better understood when read in conjunction with the appended drawings. For the purpose of illustrating the invention, there are shown in the drawings example embodiments of the invention; however, the invention is not limited to the specific methods and instrumentalities disclosed. In the drawings:

FIG. 1 is a diagram of an example conventional desktop computer in which aspects of the present invention may be implemented;

FIGS. 2A-C are diagrams of example computer configurations in which aspects of the present invention may be implemented;

FIG. 3 is a block diagram of an example software configuration in accordance with an embodiment of the invention;

FIGS. 4A-C are flowcharts of an example method of a user-initiated transaction in accordance with an embodiment of the invention;

FIG. 5 is a flowchart illustrating an example method of recognizing a user spoken command;

FIG. 6 is a flowchart illustrating an example method of a computer-initiated transaction in accordance with an embodiment of the invention;

FIG. 7 is a diagram illustrating an example software and hardware configuration in which aspects of the invention may be implemented; and

FIG. 8 is a flowchart illustrating an example method of connecting a user to a third party according to an embodiment of the invention.

### DETAILED DESCRIPTION OF ILLUSTRATIVE EMBODIMENTS

The subject matter of the present invention is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

For the purposes of the present discussion, the term “wired audio” communication or transmission means communication or transmission that travels entirely through wires. Likewise, for the purposes of the present discussion, the term “wireless audio” communication or transmission means communication or transmission that travels at least at some point wirelessly, i.e. using electromagnetic radiation through air or space (or some other extended medium), and at least at some point is, was, or will be in audio format, i.e. capable of being spoken and/or heard by a human user.

A system and method for operatively connecting a remote communications device with a computer by way of audio commands is described herein. In one embodiment of the present invention, a remote communications device such as, for example, a cellular telephone, wireless transceiver, microphone, wired telephone or the like is used to transmit an audio or spoken command to a user's computer. In another embodiment, the user's computer initiates a spoken announcement or the like to the user by way of the same remote communications device. An interface program running on the user's computer operatively interconnects, for example, voice recognition software to recognize the user's spoken utterance, text-to-speech software, audio software, and/or video software to communicate with the user, appointment and/or email software, spreadsheets, databases, the Internet or other network and/or the like. The interface program also can interface with computer I/O ports to communicate with external electronic devices such as actuators, sensors, fax machines, telephone devices, stereos, appliances, automobiles and the like. It will be appreciated that the computer may be embedded in an automobile, stereo, appliance or any other such device. In addition, the interface program can actively attempt to efficiently recognize a user's spoken command. Furthermore, the interface program can connect a user to a third party by way of, for example, Voice over Internet Protocol (VoIP) and/or the Session Initiation Protocol (SIP) standard. It will be appreciated, therefore, that an embodiment enables a user to use a portable communications device to communicate with his or her computer from any location.

For example, in one embodiment, a user may operate a cellular telephone to call his or her computer. Upon establishing communications, the user may request any type of information the software component is configured to access. In another embodiment, the computer may contact the user by way of such cellular telephone, for example, to notify the user of an appointment or the like. It will also be appreciated that the cellular telephone need not perform any voice recognition or contain any of the user information that the user wishes to access. In fact, a conventional, “off-the-shelf” cellular telephone, softphone or the like may be used with a computer running software according to one embodiment. As a result, an embodiment enables a user to use the extensive computing power of his or her computer from any location, and by using any of a wide variety of communications devices.

In the following discussion, it will be appreciated that details of implementing such software and/or hardware components and communications devices, as well as the technical aspects of interoperability, should be known to one of skill in the art and therefore such matters are omitted herein for clarity.

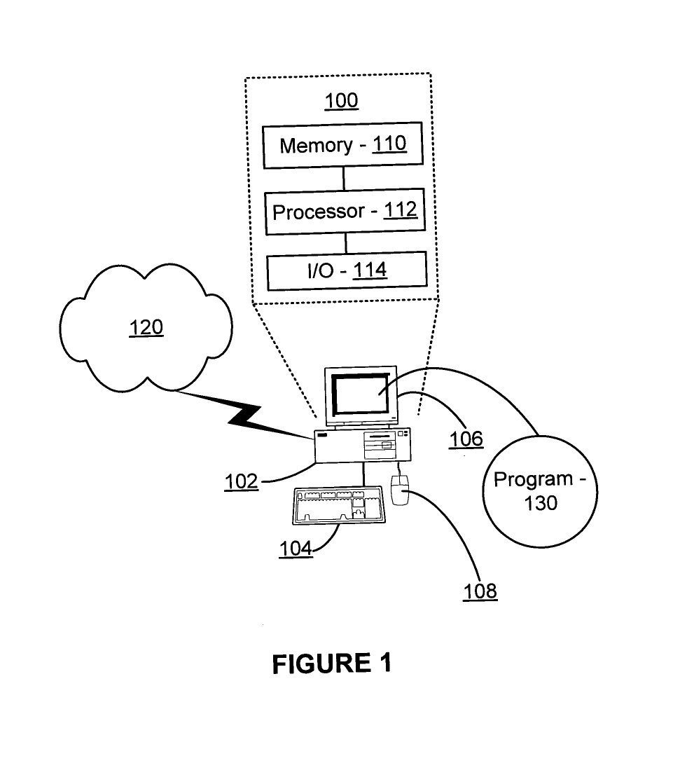

Turning now to FIG. 1, an example computer 100 in which aspects of the present invention may be implemented is illustrated. Computer 100 may be any general purpose or specialized computing device capable of performing the methods discussed herein. In one embodiment, computer 100 comprises a CPU housing 102, a keyboard 104, a display device 106 and a mouse 108. It will be appreciated that a computer 100 may be configured in any number of ways while remaining consistent with an embodiment. For example, computer 100 may have an integrated display device 106 and CPU housing 102, as would be the case with a laptop computer. In another embodiment, a computer 100 may have an alternative means of accepting user input, in place of or in conjunction with keyboard 104 and/or mouse 108. In an embodiment, a program 130 such as the interface program, a software component or the like is displayed on the display device 106. In another embodiment, computer 100 may be a CPU and associated memory, I/O, etc., that is embedded in an automobile, appliance, consumer product or the like. Thus, it will be appreciated that references herein to “computer” and “computer 100” are therefore referring to a computing device that is capable of performing any of the methods, etc., disclosed herein, and does not exclusively refer to personal computers or the like.

In yet another embodiment, computer 100 is also operatively connected (either wired or wirelessly, or both) to a network 120 such as, for example, the Internet, an intranet or the like. Computer 100 further comprises a processor 112 for data processing, memory 110 for storing data, and input/output (I/O) 114 for communicating with the network 120 and/or another communications medium such as a telephone line or the like. It will be appreciated that processor 112 of computer 100 may be a single processor, or may be a plurality of interconnected processors. Memory 110 may be, for example, RAM, ROM, a hard drive, CD-ROM, USB storage device, or the like, or any combination of such types of memory. In addition, memory 110 may be located internal or external to computer 100. I/O 114 may be any hardware and/or software component that permits a user or external device to communicate with computer 100. The I/O 114 may be a plurality of devices located internally and/or externally.

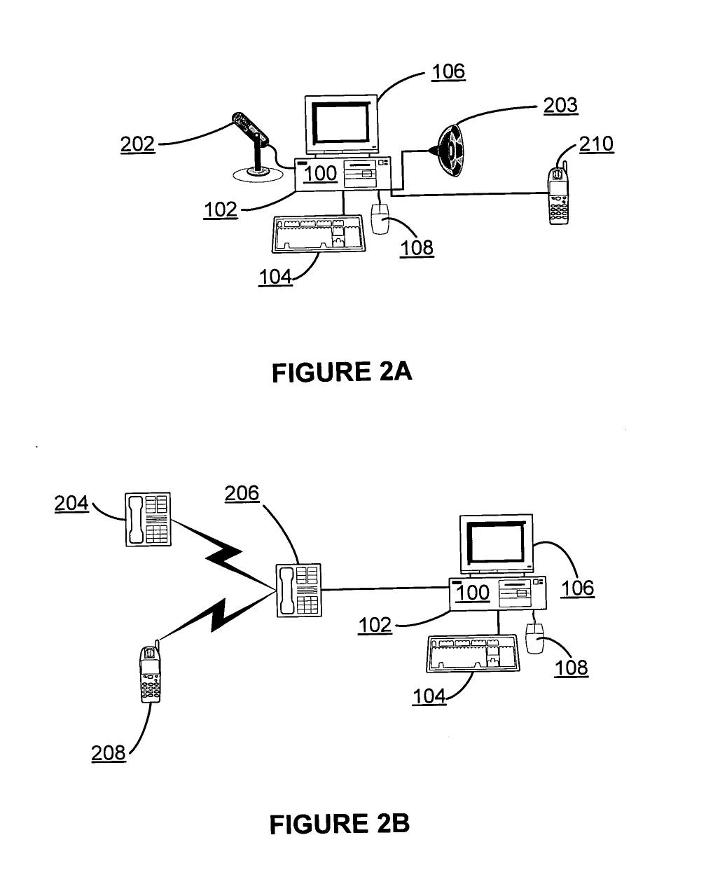

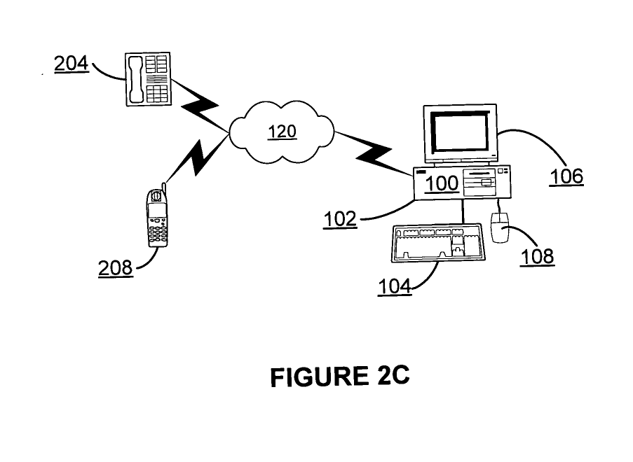

Turning now to FIGS. 2A-C, diagrams of example computer configurations in which aspects of the present invention may be implemented are illustrated. In FIG. 2A, a computer 100 having a housing 102, keyboard 104, display device 106 and mouse 108, as was discussed above in connection with FIG. 1, is illustrated. In addition, a microphone 202 and speaker 203 are operatively connected to computer 100. As may be appreciated, microphone 202 is adapted to receive sound waves and convert such waves into electrical signals that may be interpreted by computer 100. Speaker 203 performs the opposite function, whereby electrical signals from computer 100 are converted into sound waves. As may be appreciated, a user may speak into microphone 202 so as to issue commands or requests to computer 100, and computer 100 may respond by way of speaker 203. Conversely, computer 100 may initiate a “conversation” with a user by making a statement or playing a sound by way of speaker 203, by displaying a message on display device 106, or the like. As can be seen in FIG. 2A, an optional corded or cordless telephone or speakerphone may be connected to computer 100 by way of, for example, a telephone gateway connected to the computer 100, such as an InternetPhoneWizard manufactured by Actiontec Electronics, Inc. of Sunnyvale, Calif., in addition to or in place of any of keyboard 104, mouse 108, microphone 202 and/or speaker 203. As may be appreciated, a telephone 210, in one embodiment, such as a conventional corded or cordless telephone or speakerphone acts as a remote version of a microphone 202 and speaker 203, thereby allowing remote interaction with computer 100. One example of a telephone 210 designed specifically to connect to a computer 100 is the Clarisys i750 Internet telephone by Clarysis of Elk Grove Village, Ill.

In FIG. 2B, a computer 100 having a housing 102, keyboard 104, display device 106 and mouse 108, as was discussed above in connection with FIG. 1, is again illustrated. In addition, computer 100 is operatively connected to a local telephone 206. As may be appreciated, in one embodiment computer 100 is connected directly to a telephone line, without the need for an external telephone to be present. Computer 100 may be adapted to receive a signal from a telephone line, for example by way of I/O 114 (replacing local telephone 206 and not shown in FIG. 2B for clarity). In such an embodiment, I/O 114 is a voice modem or equivalent device. Optional remote telephone 204 and/or cellular telephone 208 may also be operatively connected to local telephone 206 or to a voice modem. In yet another embodiment, local telephone 206 is a cellular telephone, and communication with computer 100 occurs via a cellular telephone network.

For example, in one embodiment, a user may call a telephone number corresponding to local telephone 206 by way of remote telephone 204 or cellular telephone 208. In such an embodiment, computer 100 monitors all incoming calls for a predetermined signal or the like, and upon detecting such signal, the computer 100 forwards such information from the call to the interface program or other software component. In such a manner, computer 100 may, upon connecting to the call, receive a spoken command or request from the user and issue a response. Conversely, the computer 100 may initiate a conversation with the user by calling the user at either remote telephone 204 or cellular telephone 208. As may be appreciated, computer 100 may have telephone-dialing capabilities, or may use local telephone 206, if present, to accomplish the same function.

It will be appreciated that a telephone 204-208 may be any type of instrument for reproducing sounds at a distance in which sound is converted into electrical impulses (in either analog or digital format) and transmitted either by way of wire or wirelessly by, for example, a cellular network or the like. As may be appreciated, an embodiment's use of a telephone for remotely accessing a computer 100 ensures relatively low cost and ready availability of handsets for the user. In addition, any type or number of peripherals may be employed in connection with a telephone, and any such type of peripheral is equally consistent with an embodiment. In addition, any type of filtering or noise cancellation hardware or software may be used—either at a telephone such as telephones 204-208 or at the computer 100—so as to increase the signal strength and/or clarity of the signal received from such telephone 204-208.

Local telephone 206 may, for example, be a corded or cordless telephone for use at a location remote from the computer 100 while remaining in a household environment. In an alternate embodiment such as, for example, in an office environment, multi-line and/or long-range cordless telephone(s) may be used in connection with the present invention. It will be appreciated that while an embodiment is described herein in the context of a single user operating a single telephone 204-208, any number of users and telephones 204-208 may be used, and any such number is consistent with an embodiment. As mentioned previously, local telephone 206 may also be a cellular telephone or other device capable of communicating via a cellular telephone network.

In an alternate embodiment, telephone 206 may be, for example, long range telephony equipment, such as manufactured by EnGenius. It will be appreciated that the use of such a long range cordless telephone may be desirable in a commercial environment or the like. In an embodiment, it may be desirable for a user to have near-instant access to the computer 100 over very long ranges (e.g., while traveling throughout a city or even nationwide). In such an embodiment, Direct Connect™ from Nextel technology or the like may be used to transmit information in audio format to and from the computer 100. For example, the user would have one Direct Connect telephone, while the computer 100 would be connected to a second telephone—either another Direct Connect telephone or another type of communications device.

Devices such as pagers, push-to-talk radios, and the like may be connected to computer 100 in addition to or in place of telephones 204-208. As will be appreciated, all or most of the user's information is stored in computer 100. Therefore, if a remote communications device such as, for example, telephones 204-208 are lost, the user can quickly and inexpensively replace the device without any loss of data.

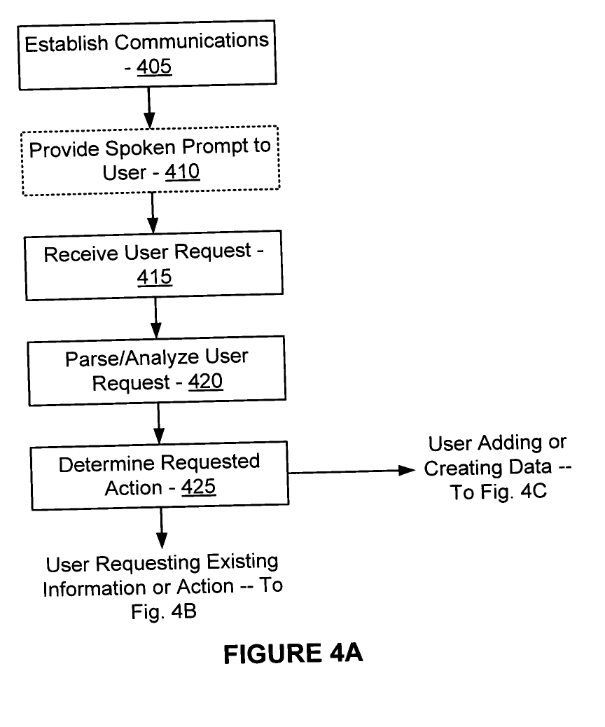

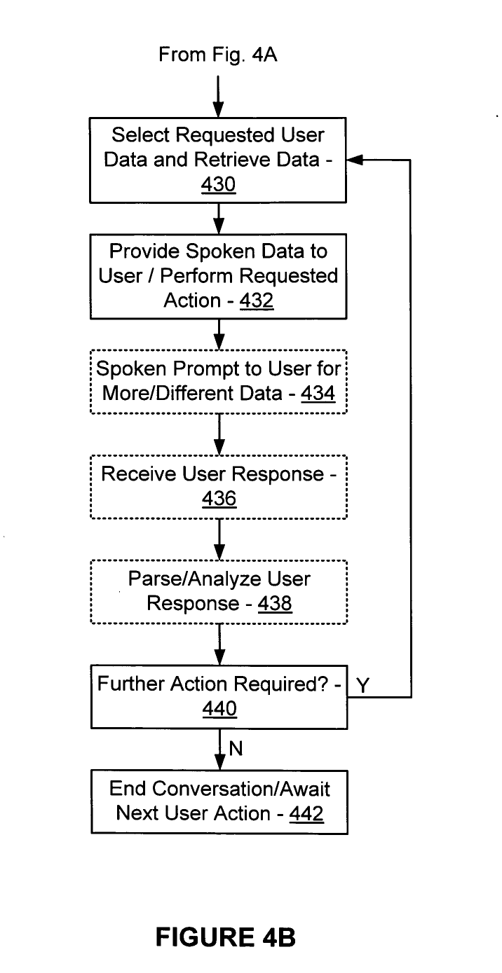

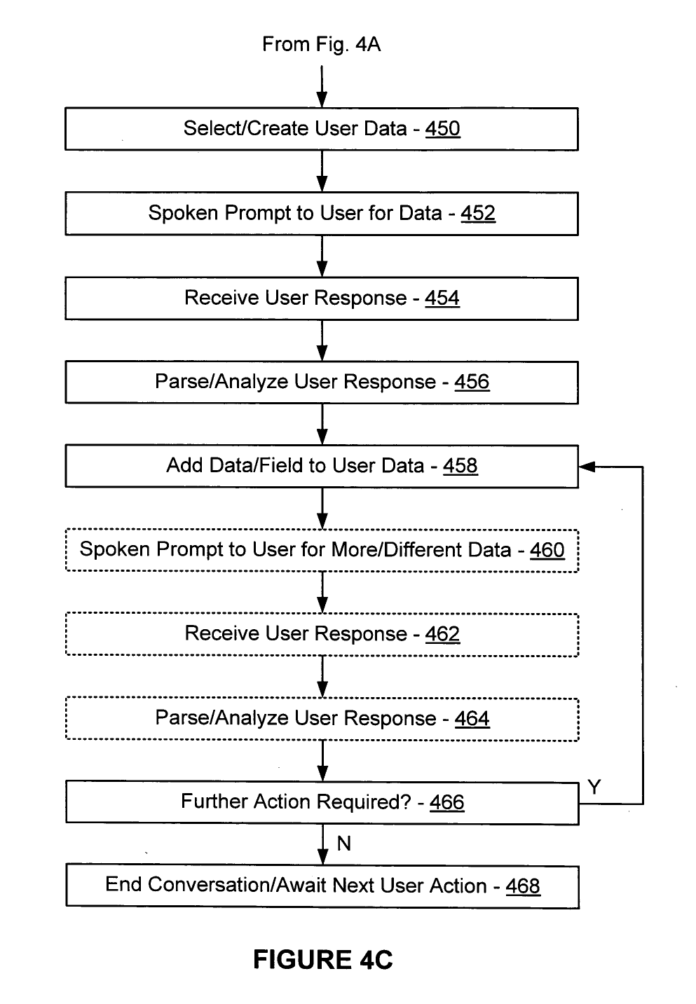

Turning now to FIG. 2C, a computer 100 having a housing 102, keyboard 104, display device 106 and mouse 108, as was discussed above in connection with FIG. 1, is once again illustrated. In contrast to the embodiment illustrated above in connection with FIG. 2B, computer 100 is operatively connected to remote telephone 204 and/or cellular telephone 208 by way of network 120. As may be appreciated, computer 100 may be operatively connected to the network 120 by way of, for example, a dial-up modem, DSL, cable modem, satellite connection, T1 connection or the like. For example, a user may call, a “web telephone” number, IP address, or conventional telephone number which has been assigned to the computer 100 or the like to connect to computer 100 by way of network 120. Likewise, computer 100 may connect to remote telephone 204 and/or cellular telephone 208 by way of network 120. In such an embodiment, it will be appreciated that computer 100 either has onboard or is in operative communications with telephone-dialing functionality in order to access network 120. Such functionality may be provided by hardware or software components, or a combination thereof, and will be discussed in greater detail below in connection with FIG. 4B.

An example of how such telephone communication may be configured is by way of a VoIP connection. In such an embodiment, any remote telephone may be able to dial the computer 100 directly, and connect to the interface program by way of an aspect of network 120. For example, the computer 100 may be equipped to handle incoming VoIP telephone calls using a broadband Internet connection or the like. In addition, a USB Internet telephone from another remote computer 100 could initiate a VoIP telephone call that would be answered directly by the computer 100, for example. It will also be appreciated that in an embodiment a SIP telephone, or even instant messaging technology or the like, could be used to communicate with computer 100.

Thus, several example configurations of a user computer 100 in which aspects of the present invention may be implemented are presented. As may be appreciated, any manner of operatively connecting a user to a computer 100, whereby the user may verbally communicate with such computer 100, is equally consistent with an embodiment.

As may also be appreciated, therefore, any means for remotely communicating with computer 100 is equally consistent with an embodiment. Additional equipment may be necessary for such computer 100 to effectively communicate with such remote communications device, depending on the type of communications medium employed. For example, the input to voice recognition software engine may generally be received from a standard input such as a microphone. Similarly, the output from a text-to-speech engine may generally be sent to a standard output device such as a speaker. In the same manner, a communications device, such as a cellular telephone, may be capable of receiving input from a (headset) microphone and transmitting output to a (headset) speaker. Accordingly, an embodiment provides connections between the speech engines and a communications device directly connected to the computer (e.g., telephone 206 as shown in FIG. 2B), so the output from the device—which would generally go to a speaker—is transferred to the input of the speech engine (which would generally come from a microphone). Likewise, there should be a connection between the output from the text-to-speech engine (which would also normally go to a speaker) to the input of the device in such a manner that the device will then forward the audio output to a remote caller.

In a basic embodiment, such transference may be accomplished between a telephone 206 that is external to the computer using patch-cords (as in FIG. 2B). In some embodiments; however, the signals not only require transference, but also conditioning. For example, if the audio signals are analog, one embodiment requires impedance matching such as can be done with a variable resistor, volume control and so forth. If the audio signals are digital, the format (e.g., sample rate, sample bits (block size), and number of channels) should be conditioned.

Another embodiment of such signal transference and conditioning may involve “softphone” software, operating at the computer 100 in conjunction with the interface program. Such software facilitates VoIP telephonic communication, placing and receiving telephone calls on a computer 100 using the aforementioned SIP standard or other protocols such as H.323. One example of such software is X-PRO, which is manufactured by Xten Networks, Inc., of Burnaby, British Columbia, Canada. Softphone software generally sends a telephonic voice signal to a user by way of local speakers or a headset, and generally receives telephone voice by way of a local microphone. Often the particular audio devices to be used by the softphone software can be selected as a user setting, as sometimes a computer 100 has multiple audio devices available. As noted above, text-to-speech software generally sends sound (output) to its local user by way of local speakers or a headset; and, voice recognition software generally receives voice (input) by way of a local microphone. Accordingly, the softphone software may be linked by an embodiment to the text-to-speech software and the voice recognition software. Such a linkage may be accomplished in any number of ways and involving either hardware or software, or a combination thereof. In one embodiment, a hardware audio device may be assigned to each application, and then the appropriate output ports and input ports are linked using patch cables. Such an arrangement permits audio to flow from the softphone to the voice recognition software, and from the text-to-speech software to the softphone software. As may be appreciated, such an arrangement may entail connecting speaker output ports to microphone input ports and therefore in one embodiment impedance-matching in the patch cables may be used to mitigate sound distortion.

Another embodiment may use special software to link the audio signals between applications. An example of such software may be Virtual Audio Cable (software written by Eugene V. Muzychenko), which emulates audio cables entirely in software, so that different software programs that send and receive audio signals can be readily connected. In such an embodiment, a pair of Virtual Audio Cables may be configured to permit audio to flow from the softphone to the voice recognition software, and from the text-to-speech software to the softphone software. In yet another embodiment, the softphone software, the text-to-speech software and the voice recognition software are modified or otherwise integrated so the requirement for an external audio transference device is obviated entirely.

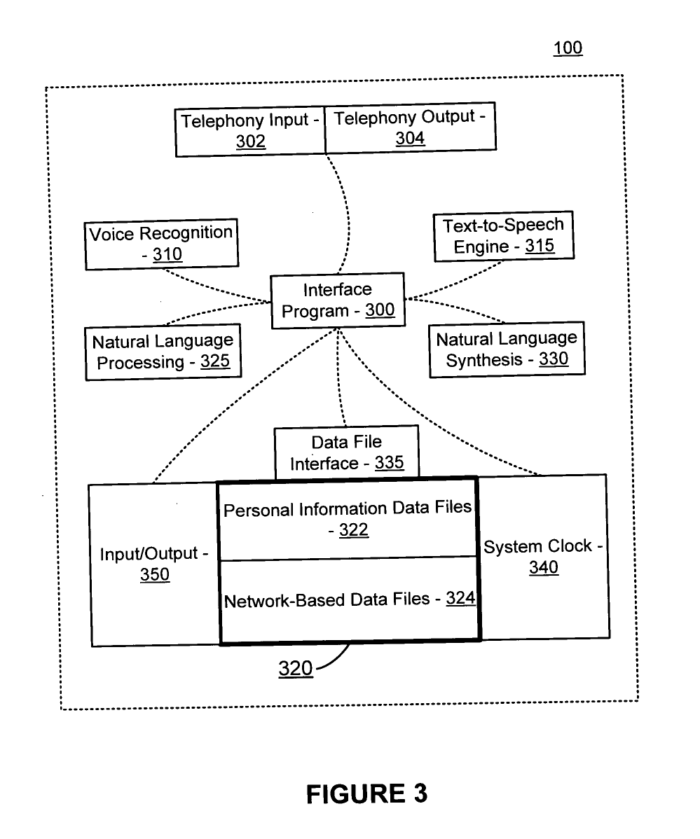

Turning now to FIG. 3, a block diagram of an example software and/or hardware configuration in accordance with an embodiment is illustrated. As may be appreciated, in one embodiment, such software is run by the computer 100. In such a manner, the computing power of such computer 100 is utilized, rather than attempting to implement such software on a remote communications device such as, for example, telephones 204-210 as discussed above in connection with FIGS. 2A-C (not shown in FIG. 3 for clarity).

It will be appreciated that each software and/or hardware component illustrated in FIG. 3 is operatively connected to at least one other software and/or hardware component (as illustrated by the dotted lines). In addition, it will be appreciated that FIG. 3 illustrates only one embodiment, as other configurations of software and/or hardware components are consistent with an embodiment as well. It will be appreciated that the software components illustrated in FIG. 3 may be stand-alone programs, application program interfaces (APIs), or the like. In addition, such software components may be implemented as computer-executable instructions on a computer-readable medium, where the instructions may be executed by a computer or the like to perform the steps discussed below. Computer-readable media may include, for example, a CD-ROM disk, a DVD disk, USB drive, and the like. Some software components already may be present within a computer, thus substantially lowering costs, reducing complexity, saving storage space and improving efficiency.

A telephony input 302 is any type of component that permits a user to communicate by way of spoken utterances or audio commands (including, but not limited to, DTMF signals) with the computer 100 via, for example, input devices as discussed above in connection with FIGS. 2A-C. Likewise, a telephony output 304 is provided for outputting electrical signals as sound for a user to hear. It will be appreciated that both telephony input 302 and telephony output 304 may be adapted for other purposes such as, for example, receiving and transmitting signals to a telephone or to network 120, including having the functionality necessary to establish a connection by way of such telephone or network 120. Telephony input 302 and output 304 may be hardware internal or external to the computer 100, or software such a softphone application and associated network interface card.

Also provided is voice recognition software 310 which, as the name implies, is adapted to accept an electronic signal—such as a signal received by telephony input 302—wherein the signal represents a spoken utterance by a user, and to decipher such utterance. Voice recognition software 310 may be, for example, any type of specialized or off-the-shelf voice recognition software, or a component of such software, such as for example a voice recognition software 310 engine. Such recognition software 310 may include user training for better-optimized voice recognition. In addition, a text-to-speech engine 315 for communicating with a user is illustrated. Such text-to-speech engine 315, in an embodiment, generates spoken statements from electronic data, that are then transmitted to the user. In an embodiment as illustrated in FIG. 3, a natural language processing module 325 and a natural language synthesis module 330 are provided to interpret and construct, respectively, spoken statements.

User data 320 comprises any kind of information that is stored or accessible to computer 100, and that may be accessed and used in accordance with an embodiment. For example, a personal information data file 322 may be any type of computer file that contains any type of information. Email, appointment files, personal information and the like are examples of the type of information that is stored in a personal information database. Additionally, such a personal information data file 322 may be a type of file such as, for example, a spreadsheet, database, document file, email data, and so forth. Furthermore, such a data file 322 (as well as data file 324, below) may be able to perform tasks at the user's direction such as, for example, open a garage door, print a document, send a fax, send an e-mail, turn on and/or control a household appliance, record or play a television or radio program, interface with communications devices and/or systems, and so forth. Such functionality may be included in the data file 322-324, or may be accessible to such data file 322-324 by way of, for example, telephony input 302 and output 304, Input/Output 350, and/or the like. It will be appreciated that the interface program 300 may be able to carry out such tasks using components, such as those discussed above, that are internal to the computer 100, or the program 300 may interface—using telephony input 302 and output 304, Input/Output 350, and/or the like—with devices external to the computer 100.

An additional file that may be accessed by computer 100 on behalf of a user is a network-based data file 324. Such a data file 324 contains macros, XML tags, or other functionality that accesses a network 120, such as the Internet, to obtain up-to-date information for the user. Such information may be, for example, stock prices, weather reports, news, traffic reports and the like. An example file might be a personal information management (PIM) file or a messaging application programming interface (MAPI, e.g., e-mail) file. These files may be used in conjunction with programs such as Microsoft® Outlook® or Lotus Notes®. Alternatively, interface program 300 may interact directly with various computer programs, for example by way of interop methods (as will be understood by those versed in computer programming).

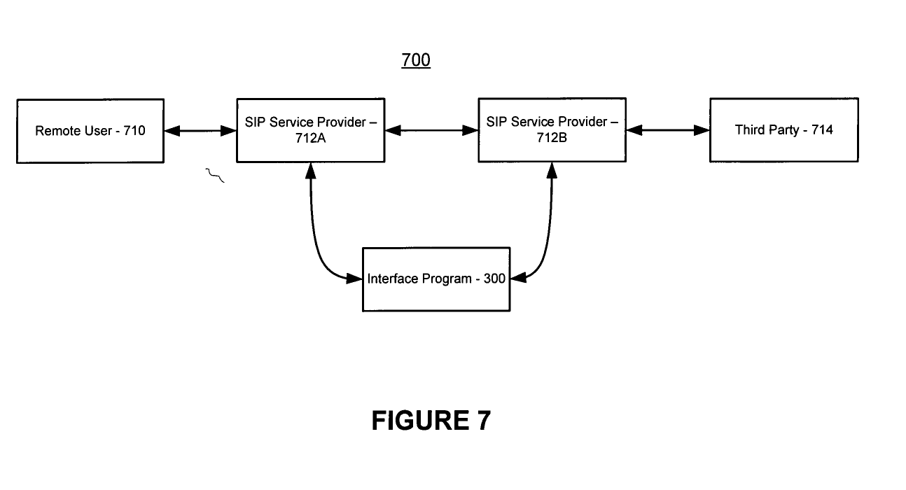

Another example of such a data file 324 will be discussed below in the context of an Internet-enabled spreadsheet in FIGS. 7A-B. As will be appreciated, the term user data 320 as used herein refers to any type of data file including the data files 322 and/or 324. A data file interface 335 is provided to permit the interface program 300 to access the user data 320. As may be appreciated, there may be a single data file interface 335, or a plurality of interfaces 335 which may interface only with specific files or file types. Also, in one embodiment, a system clock 340 is provided for enabling the interface program 300 to determine time and date information. In addition, in an embodiment an Input/Output 350 is provided for interfacing with external devices, components, and the like. For example, Input/Output 350 may comprise one or more of a printer port, serial port, USB port and/or the like.

Operatively connected (as indicated by the dotted lines) to the aforementioned hardware and software components is the interface program 300. However, the interface program 300 itself is either a stand-alone program, or a software component that orchestrates the performance of tasks in accordance with an embodiment. For example, the interface program 300 controls the other software components, and also controls what user data 320 is open and what “grammars” (expected phrases to be uttered by a user) are listened for.

It will be appreciated that the interface program 300 need not itself contain the user data 320 in which the user is interested. In such a manner, the interface program 300 remains a relatively small and efficient program that can be modified and updated independently of any user data 320 or other software components as discussed above. In addition, such a modular configuration enables the interface program 300 to be used in any computer 100 that is running any type of software components. As a result, compatibility concerns are alleviated. Furthermore, it will be appreciated that the interface program's 300 use of components and programs that are designed to operate on a computer 100, such as a personal computer, enables sophisticated voice recognition to occur in a non-server computing environment. Accordingly, the interface program 300 interfaces with programs that,are designed to run on a computer 100—as opposed to a server—and are familiar to a computer 100 user. For example, such programs may be preexisting software applications that are part of, or accessible to, an operating system of computer 100. As may be appreciated, such programs may also be stand-alone applications, hardware interfaces, and/or the like.

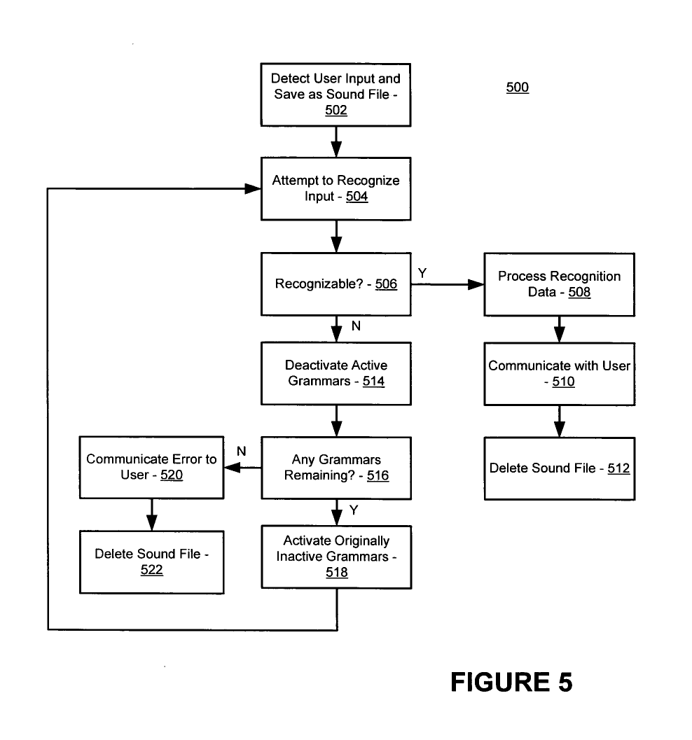

It will also be appreciated that the modular nature of an embodiment allows for the use of virtually any voice recognition software 310. However, the large variances in human speech patterns and dialects limit the accuracy of any such recognition software 310. Thus, in one embodiment, the accuracy of such software 310 is improved by limiting the context of the spoken material the software 310 is recognizing. For example, if the software 310 is limited to recognizing words from a particular subject area, the software 310 is more likely to correctly recognize an utterance—that may sound similar to any number of unrelated words—as a word that is related to the desired subject area. A method of resolving a user voice command using such context limiting is discussed below in connection with FIG. 5.

In one embodiment, the user data 320 that is accessed by the interface program 300 may be configured and organized in such a manner as to perform such context limiting. Such configuration can be done in the user data 320 itself, rather than requiring a change to the interface program 300 or other software components as illustrated in FIG. 3. For example, a spreadsheet application such as Microsoft® Excel or the like provides a means for storing and accessing data in a manner suitable for use with the interface program 300. Script files, alarm files, look-up files, command files, solver files and the like are all types of spreadsheet files that are available for use in an embodiment.

In addition, it will be appreciated that voice recognition software 310 may have one or more settings that constitute a “profile.” A voice recognition software 310 profile may be created for any number of reasons including, but not limited to, the type of communication channel used by a user to communicate with the interface program 300, or the like.

A script file is a spreadsheet that provides for a spoken dialogue between a user and a computer 100. For example, in one embodiment, one or more columns (or rows) of a spreadsheet represent a grammar that may be spoken by a user—and therefore will be recognized by the interface program 300—and one or more columns (or rows) of the spreadsheet represent the computer's 100 response. Thus, if a user says, for example, “hello,” the computer 100 may say “hi” or “good morning” or the like. Such a script file thereby enables a more user-friendly interaction with a computer 100.

An alarm file, in one embodiment, has entries in one or more columns (or rows) of a spreadsheet that correspond to a desired function. For example, an entry in the spreadsheet may correspond to a reminder, set for a particular date and/or time, for the user to take medication, attend a meeting, etc. Thus, the interface program 300 interfaces with a component such as the telephony output 304 to contact the user and inform him or her of the reminder. Thus, it will be appreciated that an alarm file is, in some embodiments, always active because it should be running to generate an action upon a predetermined condition.

A look-up file, in one embodiment, is a spreadsheet that contains information or is cross-referenced to information. In one embodiment, the information is contained entirely within the look-up file, while in other embodiments the look-up file references information from data sources outside of the look-up file. For example, spreadsheets may contain cells that reference data that is available on the Internet (using, for example, “smart tags,” web queries, database queries, or the like), and that can be “refreshed” at a predetermined interval to ensure the information is up-to-date. Therefore, a look-up file may be used to find information for a user such as, for example, stock quotes, sports scores, weather conditions and the like. It will be appreciated that such information may be stored locally or remote to computer 100.

A command file, in one embodiment, is a spreadsheet that allows a user to input commands to the computer 100 and to cause the interface program 300 to interface with an appropriate component to carry out the command. For example, the user may wish to hear a song, and therefore the interface program 300 interfaces with a music program to play the song. A solver file, in one embodiment, allows a user to solve mathematical and other analytical problems by verbally querying the computer 100. In each type of file, the data contained therein is organized in a series of rows and/or columns, which include “grammars” or links to grammars which the voice recognition software 310 should recognize to be able to determine the data to which the user is referring.

As noted above, a script file represents a simple application of spreadsheet technology that may be leveraged by the interface program 300 to provide a user with the desired information or to perform the desired task. It will be appreciated that, depending on the particular voice recognition software 310 being used in an embodiment, the syntax of such scripts affects what such software is listening for in terms of a spoken utterance from a user.

An embodiment is configured so as to only open, for example, a lookup file when requested by a user. In such a manner, the number of grammars that the computer 100 must potentially decipher is reduced, thereby increasing the speed and reliability of any such voice recognition. In addition, such a configuration also frees up computer 100 resources for other activities. If a user desires to open such a file, the user may issue a verbal command such as, for example, “look up stock prices” or the like. The computer 100 then determines which data file 322-324, or the like corresponds to the spoken utterance and opens it. The computer then 100 informs the user, by way of a verbal cue, that the data is now accessible.

In an alternate embodiment, the user would not complete the spreadsheets or the like using the standard spreadsheet technology. Instead, a wizard, API or the like may be used to fill, for example, a standard template file. In another embodiment, the voice recognition technology discussed above may be used to fill in such a template file instead of using a keyboard 104 or the like. In yet another embodiment, the interface program 300 may prompt the user with a series of spoken questions, to which the user speaks his or her answers. In such a manner, the computer 100 may ask more detailed questions, create or modify user data 320, and so forth. Furthermore, in yet another embodiment, a wizard converts an existing spreadsheet, or one downloaded from the Internet or the like, into a format that is accessible and understandable to the interface program 300.

As discussed above in connection with FIGS. 2A-C, it will be appreciated that a single user may also require a different software configuration (or “mode”) depending on the communications channel employed by the user. For example, if the user is contacting the computer 100 by way of a cellular telephone 208, the computer 100 may need to use a voice recognition software 310 profile that has been adjusted to recognize speech from the relatively low sound quality signal provided by that medium. Thus, a voice recognition software 310 profile may be present for recognizing user commands that are received by way of a cellular telephone 208. In addition, the computer 100 may need to make different data files 322 or the like available to the user depending on the communication channel employed by the user. For example, a user may always desire to have access to certain information when calling from a cellular telephone 208 (e.g., because the user is on the road and desires such information) that the user does not desire when using the microphone 202 (e.g., because the user is in front of the computer and can access such information by other means). In addition, it will be appreciated that multiple users of a computer 100 may each have different configuration settings for a variety of communication channels. Thus, in the discussion that follows, aspects of an embodiment are described that provides a means by which such configuration changes may be effectuated.

As noted above, a user may use different communications channels to interact with computer 100. The hardware involved with each communications channel may have a different audio quality. For example, different communication channels may have, for example, different sampling rates (e.g., 8 kHZ for telephony equipment, 16 kHz for speakers, 22.05 kHz for microphones, 44.1 KHz for CDs, 48 KHz for DVDs, 96 KHz for DVD-Audio, etc.). Thus, and as noted above, a mode change or the like may need to be made, depending on the hardware involved. For example, a user may desire to train the voice recognition software 310 to create a profile for each communication channel through which the user connects to the computer 100. It will be appreciated that a user may desire that many settings and/or software changes occur when using different communication channels. For example, a user may desire that an embodiment automatically change output devices, adjust input gain and output volume to previously-stored settings, change voice recognition software 310 settings or engines (e.g. 8 kHz optimized to 16 kHz optimized), change a voice recognition software 310 profile (e.g., user 1 on a cellular telephone to user 1 on a microphone), change audio format conversion parameters, change background noise filtering preferences/profiles, change “history” and/or “context” files, change other preferences or setup parameters, change available data files 322 or function sets within the data files 322, or preferences for various functions, and/or the like.

In one embodiment, such changes may be pre-configured with some or all these parameters to allow automatic switching between hardware devices. For example, the interface program 300 could be set to a microphone and speakers configuration (i.e., a “local” mode), but would be “listening” for other devices, such as a telephone call from VoIP. It will be appreciated that “listening” means the interface program 300 is able to recognize a new device connection, such as an incoming telephone call or the like by way of, for example, telephony input 302 or Input/Output 350. In the event that such a telephone call is incoming, the interface program 300 may automatically switch modes and adjust all of the necessary parameters to enhance performance for the new (i.e., VoIP) mode. Once the VoIP connection is no longer operating, the interface program 300 may, in an embodiment, automatically switch back to the local mode.

To continue the above VoIP example, it will be appreciated that to accept a VoIP telephone call, the interface program 300 may require some form of audio bridge in hardware and/or software or the like that may be used to connect the computer 100 to the VoIP call by way of telephony input 302, telephony output 304, Input/Output 350, or the like. In addition, some telephony equipment compresses and digitizes the analog signal in a different manner and a different sample rate than other audio equipment. Thus, these parameters may be switched automatically by the interface program 300 to allow the user to switch from a local to a VoIP mode. For example, when the interface program 300 is in a local mode and detects an incoming call from a softphone to which it may be linked by way of Input/Output 350 to receive VoIP calls, the interface program 300 “gives up” the local audio devices and establishes communications with the softphone. Generally, this may require additional software, such as provided by Virtual Audio Cables (as discussed above) or the like. In addition, parameters on the softphone may need to be changed to optimize communication with the interface program 300. Furthermore, the interface program 300 may need to switch to the user's VoIP voice recognition software 310 profile (if present). When the VoIP call is finished, the interface program 300 may reclaim the local audio devices, and terminate communication with the Virtual Audio Cables.

It will be appreciated that any type of software and/or hardware changes (or lack thereof) are consistent with an embodiment. For example, an embodiment may use a different voice recognition software 310 profile and/or engine for each type of hardware that a user may use to communicate with computer 100 and interface program 300. It should be appreciated that more than one mode may be active at a single time, and therefore that multiple hardware and/or software configurations may be supported simultaneously.

As noted above, the interface program may have profiles for different users. For example, a particular user's voice may be recognized as arriving by way of a particular communication channel, and the interface software may then switch to that user's profile for the particular communication channel being used.

In one embodiment, the interface program 300 may permit only a “secure” remote user to access the computer 100. In such an embodiment, for example, once the interface program 300 has established the correct hardware settings for a remote user, the interface program 300 may answer the call with a spoken prompt (e.g., by way of text-to-speech engine 315) or the like to induce the user to provide a security code, Dual Tone Multi-Frequency (DTMF) code, spoken code phrase, etc. If the correct response is not received, the interface program 300 may prompt for additional attempts to supply the correct response. Ultimately, if the correct response is not received, the interface program may prevent access to the computer 100 and/or terminate the call.

As noted above, an embodiment provides that different software profiles may be maintained for multiple users of the computer 100. In such an embodiment, the interface program 300 may, for example, recognize a particular user from the type of device being used to communicate with the computer 100, from an input code, or the like. In response, the interface program 300 may load the appropriate user profile and/or make other setting changes as required.

For example, the interface program 300 may determine that if an input signal from a user is received by way of a particular type of hardware device, then the interface program 300 should output speech from the text-to-speech engine 315 to the user by way of an appropriate device. For example, if a user is communicating with interface program 300 by way of a designated microphone or microphones, the interface program 300 may send output of the text-to-speech engine 315 to a specified speaker or speakers.

As discussed above, multiple users may have different user profiles on computer 100. It will be appreciated that the interface program 300 may use such user profiles to properly configure hardware and/or software components. Table 1, below, illustrates example user profiles that contain various configuration settings that may be made available to each user. It will be appreciated that the settings depicted in Table 1 are in no way an exhaustive or required list.

TABLE 1
Example User Profiles
User Number One

| | | | |
|---|---|---|---|
| Names | User Name: Chris | PC Name: Judy | TTS Voice: Microsoft Mary |
| Security | Pass Phrase: | Hello Judy, this is Chris. How are you? | |
| Local Audio 1 | Input: Labtec microphone | Output: SB Live! Sound Card | SR Profile: Chris on a microphone |
| Local Audio 2 | Input: USB Phone | Output: USB Phone | SR Profile: Chris on a microphone |
| SIP Audio 1 | Phone: 1234567890 | Proxy: iConnectHere | SR Profile: Chris on a Cell |
| SIP Audio 2 | Phone: 1234567891 | Proxy: iConnectHere | SR Profile: Chris on a Cell |
| Alarms | alarms_chris.xls | Phone: 1234567890 | Output: SB Live! Card |
| Outlook | Profile: Chris Mc | Hot List: PAL Hot List | Saved Mail: PAL Saved Mail |
| Miscellaneous | Calc: 2 places | Notes: Yellow | Calendar: 7 days past |
| | Traffic: phl_west.xls | Scripts: scripts_chris.xls | E-mail: chrismc@mail.com |

User Number Two

| | | | |
|---|---|---|---|
| Names | User: Graham | PC: Bullwinkle | TTS Voice: Microsoft Mike |
| Security | Pass Phrase: | Yo dude. What's happening? | |
| Local Audio 1 | Input: Actiontec #1 In | Output: Actiontec #1 Out | SR Profile: Graham Local |
| SIP Audio 1 | Phone: 1234567892 | Proxy: Unimessaging.net | SR Profile: Graham Remote |
| SIP Audio 2 | Phone: 1234567893 | Proxy: Unimessaging.net | SR Profile: Graham Remote |
| Alarms | alarms_graham.xls | Phone: 1234567892 | Output: (none) |
| Outlook | Profile: Graham | Hot List: PAL Hot List | Saved Mail: PAL Saved Mail |
| Miscellaneous | Calc: 2 places | Notes: Yellow | Calendar: 7 days past |
| | Traffic: (none) | Scripts: scripts_graham.xls | E-mail: graham@mail.com |

User Number Three

| | | | |
|---|---|---|---|
| Names | User: Stacey | PC: Maxwell | TTS Voice: Microsoft Sam |
| Security | Pass Phrase: | Hi Maxwell, do you have a minute or two? | |
| Local Audio 1 | Input: Actiontec #2 In | Output: Actiontec #2 Out | SR Profile: Stacey on a Cordless |
| SIP Audio 1 | Phone: 1234567894 | Proxy: Unimessaging.net | SR Profile: Stacey on a Cell |
| Alarms | alarms_shris.xls | Phone: 1234567894 | Output: (none) |
| Outlook | Profile: Stacey Mc | Hot List: PAL Hot List | Saved Mail: PAL Saved Mail |
| Miscellaneous | Calc: 2 places | Notes: Yellow | Calendar: 7 days past |
| | Traffic: phl_ctrl.xls | Scripts: scripts_stacey.xls | E-mail: staceymc@mail.com |

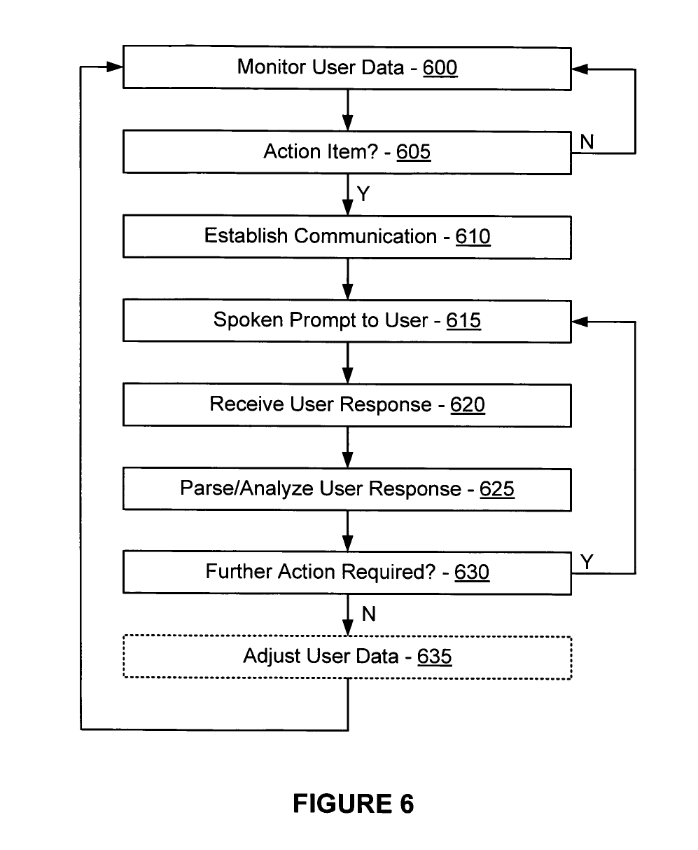

For example, in Table 1, it can be seen that one or more SIP proxies and a number of local audio devices can be assigned to each user. While such configuration settings are not mandatory, it will be appreciated a profile may have one or more output devices linked to an input device. Thus, it will be appreciated that the interface program 300 may be operated in a variety of configurations in order to communicate with user. Now that such a method of switching between such configurations has been discussed, and turning now to FIGS. 4A-C, flowcharts of an example method of a user-initiated transaction in accordance with an embodiment are shown. As was noted in the discussion of alarm scripts in connection with FIG. 3, above, it will be appreciated that in one embodiment the interface program 300, by way of telephony output 304, is able to initiate a transaction as well. Such a situation is discussed below in connection with FIG. 6.

At step 405, a user establishes communications with the computer 100. Such an establishment may take place, for example, by the user calling the computer 100 by way of a cellular telephone 208 as discussed above in connection with FIGS. 2B-C. It will be appreciated that such an establishment may also have intermediate steps that may, for example, establish a security clearance to access the user data 320 or the like. At optional step 410, a “spoken” prompt is provided to the user. Such a prompt may simply be to indicate to the user that the computer 100 is ready to listen for a spoken utterance, or such prompt may comprise other information such as a date and time, or the like.

At step 415, a user request is received by way of, for example, the telephony input 302 or the like. At step 420, the user request is parsed and/or analyzed to determine the content of the request. Such parsing and/or analyzing is performed by, for example, the voice recognition module 310 and/or the natural language processing module 325. At step 425, the desired function corresponding to the user's request is determined. It will be appreciated that steps 410-425 may be repeated as many times as necessary for, for example, voice recognition software 310 to recognize the user's request. Such repetition may be necessary, for example, when the communications channel by which the user is communicating with the computer 100 is of poor quality, the user is speaking unclearly, or for any other reason.

If the determination of step 425 is that the user is requesting existing information or for computer 100 to perform an action, the method proceeds to step 430 of FIG. 4B. For example, the user may wish to have the computer 100 read his or her appointments for the following day. If instead the determination of step 425 is that the desired function corresponding to the user request is to add or create data, the method proceeds to step 450 of FIG. 4C. For example, the user may wish to record a message, enter a new telephone number for an existing or new contact, and/or the like.

Thus, and turning now to FIG. 4B, at step 430 the requested user data 320 is selected and retrieved by interface program 300. As noted above in connection with FIG. 3, an appropriate data file interface 335 is activated by the interface program 300 to interact with user data 320 and access the requested information. Alternatively, such an interface 335 may be adapted to perform a requested action using, for example, Input/Output 350. At step 432, the interface program 300 causes either the text-to-speech engine 315 and/or the natural language synthesis component 330 to generate a spoken answer based on the information retrieved from the user data 320, and/or causes a desired action to occur. If the requested data requires it, at optional step 434, a spoken prompt is again provided to the user to request additional user data 320, or to further clarify the original request. At optional step 436, a user response is received, and at optional step 438 the response is again parsed and/or analyzed. It will be appreciated that such optional steps 434-438 are performed as discussed above in connection with steps 410-420 of FIG. 4A. It will also be appreciated that such steps 434-438 are optional because if the desired function is for the interface program 300 to perform an action (such as, for example, to open a garage door, send a fax, print a document or the like, record a note or email, send an email) no response may be necessary, although a response may be generated anyway (e.g., to inform the user that the action was carried out successfully). At step 440, a determination is made as to whether further action is required. If so, the method returns to step 430 for further user data 320 retrieval. If no further action is required, at step 442 the conversation ends (if, for example, the user hangs up the telephone) or is placed in a standby mode to await further user input.

It will be appreciated that step 425 could result in a determination that the user is requesting a particular action be performed. For example, the user may wish to initiate a telephone call. In such an embodiment, the interface program 300 may direct SIP softphone software by way of telephony input and output 302 and 304, Input/Output 350, and/or the like (not shown in FIG. 4B for clarity) to place a call to a telephone number as directed by the user. In another embodiment, the user could request a call to a telephone number that resides in, for example, the Microsoft® Outlook® or other contact database. In such an embodiment the user requests that the program 300 call a particular name or other entry in the contact database and the program 300 causes the SIP softphone to dial the telephone number associated with that name or other entry in the contact database. It will be appreciated that, while the present discussion relates to a single telephone call, any number of calls may be placed or connected, thereby allowing conference calls and the like.

When placing a call in such an embodiment, the program 300 initiates, for example, a conference call utilizing the SIP telephone, such that the user and one or more other users are connected together on the same line and, in addition, have the ability to verbally issue commands and request information from the program. Specific grammars would enable the program to “listen” quietly to the conversation among the users until the program 300 is specifically requested to provide information and/or perform a particular activity. Alternatively, the program 300 “disconnects” from the user once the program has initiated the call to another user or a conference call among multiple users.

As discussed above in connection with FIG. 4A, the user may desire to add or create data instead of simply requesting to retrieve such data or take a specified action. Thus, referring now to FIG. 4C, at step 450 user data 320, in the form of a new database, spreadsheet or the like—or as a new entry in an existing file—is selected or created in accordance with the user instruction received in connection with FIG. 4A, above. At step 452, a spoken prompt is provided to the user, whereby the user is instructed to speak the new data or instruction. At step 454, the user response is received, and at step 456, the response is parsed and/or analyzed. At step 458, the spoken data or field (which may take the form of an audio recording) is added to the user data 320 that was created or selected in step 450. At optional step 460, if necessary, a spoken prompt is again provided to the user to request additional new data. At optional step 462, such data is received in the form of the user's spoken response, and at optional step 464, such response is parsed and/or analyzed. At step 466, a determination is made as to whether further action is required. If so, the method returns to step 458 to add the spoken data or field to the user data 320. If no further action is required, at step 468 the conversation ends or is placed in a standby mode to await further user input. It will be appreciated that such prompting and receipt of user utterances takes place as discussed above in connection with FIGS. 4A-B.

As discussed above in connection with FIG. 3, the interface program 300 may limit the size of the a grammar to a particular subset of an entire vocabulary of words and/or phrases that may be used to recognize a user's spoken command by the voice recognition software 310 to enhance performance. In one embodiment, the grammar is limited to a particular context in which the user is expected to issue a spoken command. Thus, and turning now to FIG. 5, an example method 500 of recognizing a user voice command using such context limiting is discussed below in connection with FIG. 5. At step 502, a user's spoken input is detected and saved as a sound file. It will be appreciated that any format of sound file is consistent with an embodiment, such as for example a e.wav file, .mp3 file or the like. At step 504, the interface program 300 and/or voice recognition software 310 attempts to recognize the input using an active grammar. It will be appreciated that the active grammar may be selected based on any number or type of factors, such as for example, the type of hardware being used by the user, the time of day, weather conditions, calendar or appointment information, a prior user request, a user configuration setting, and the like. The selection of active grammar may be further enhanced by statistical approaches the correlate likely active grammars (i.e., the subject matter of the current request) with previous requests and/or various contextual factors as previously mentioned. For example, a request regarding an appointment may suggest that probable ensuing requests could be about the time of day, or the location of a meeting place (i.e., the office address of a particular contact). In addition, any number of grammars may be active at any given time.

At step 506, a determination is made as to whether the user input was recognized. If so, the method 500 proceeds to step 508 to process the recognition data. Such processing may be, for example, carrying out a requested task, granting the user access to computer 100 or the like. At step 510, the method 500 communicates with the user by way of, for example, text-to-speech engine 315. If the user's command did not require a verbal response from the interface program 300 and/or voice recognition software 310, then step 510 may be optional. Finally, at step 512, the sound file containing the user input is deleted to preserve memory space, for example.

If the determination of step 506 is that the user input was not recognized, then the active grammar(s) is deactivated at step 514. At step 516, a determination is made as to whether any grammars (that, for example, were not active during steps 504-506) are available. If so, such grammars are activated at step 518 and the method 500 returns to step 504 to attempt to recognize the user input. If the determination of step 516 is that no additional grammars are available, then the method 500 communicates an error to the user at step 520. It will be appreciated that such error communication of step 520 may involve prompting the user to repeat the command, prompting the user to provide an alternate description or category in which the command might fall, or the like. Finally, at step 522 the sound file is deleted to preserve memory space, for example. It will be appreciated that the method 500 may take place any number of times in order to recognize a user input. For example, at step 518, the method 500 need not activate all grammars that were not previously active. Instead, an embodiment may provide that one or more grammars are intelligently selected to have the highest probability of providing a match to the user input.

It will be appreciated that a user may direct the interface program 300 to activate a particular grammar so as to increase the likelihood of the interface program 300 and/or voice recognition software 310 recognizing the user's next input. For example, a user input of “Look up my Contacts” could prompt the interface program 300 to open a grammar that is related to the user's contacts, as well as opening the contacts itself. In addition, a general grammar may be provided by an embodiment, whereby the general grammar may have the most common commands that may be received from a user. In such a manner, the user may be likely to have a command understood by the interface program 300, even if the user is issuing a command that is unrelated to the context in which the user is operating.

Now that a method of recognizing a user input has been discussed, the method of FIG. 6 is an example method of a computer 100 -initiated transaction in accordance with an embodiment. Accordingly, and referring now to FIG. 6, at step 600 user data 320 is monitored. As may be appreciated, multiple instances of user data 320 may be monitored by interface program 300 such as, for example, an alarm file, an appointment database, an email/scheduling program file and the like. At step 605, a determination is made as to whether the user data 320 being monitored contains an action item. It will be appreciated that in an embodiment the interface program 300 is adapted to use the system clock 340 to, for example, review entries in a database and determine which currently-occurring items may require action. If no action items are detected, the interface program 300 continues monitoring the user data 320 at step 600. If the user data 320 does contain an action item, the interface program 300, at step 610, initiates a conversation with the user. Such an initiation may take place, for example, by the interface program 300 causing a software component to contact the user by way of a telephone 204 or cellular telephone 208. Any of the hardware configurations discussed above in connection with FIGS. 2A-C are capable of carrying out such a function.

At step 615, a spoken prompt is issued to the user. For example, upon the user answering his or her cellular telephone 208, the interface program 300 causes the text-to-speech engine 315 to generate a statement regarding the action item. It will be appreciated that other, non-action-item-related statements may also be spoken to the user at such time such as, for example, security checks, pleasantries, and the like. At step 620, the user response is received, and at step 625, the response is parsed and/or analyzed as discussed above in connection with FIGS. 4A-B. At step 630, a determination is made as to whether further action is required, based on the spoken utterance. If so, the method returns to step 615. If no further action is required, at optional step 635 the interface program 300 makes any adjustments that need to be made to user data 320 to complete the user's request such as, for example, causing the database interface 320 to save changes or settings, set an alarm, and the like. The interface program 300 then returns to step 600 to continue monitoring the user data 320. It will be appreciated that the user may disconnect from the computer 100, or may remain connected to perform other tasks. In fact, the user may then, for example, issue instructions that are handled according to the method discussed above in connection with FIGS. 4A-C.

Thus, it will be appreciated that interface program 300 is capable of both initiating and receiving contact from a user with respect to user data 320 stored on or accessible to computer 100. It will also be appreciated that interface program 300, in some embodiments, runs without being seen by the user, as the user accesses computer 100 remotely. However, the user may have to configure or modify interface program 300 so as to have such program 300 operate according to the user's preferences. As noted above, one of skill in the art should be familiar with the programming and configuration of user interfaces for display on a display device of a computer 100, and therefore the details of such configurations are omitted herein for clarity.

As noted above, the interface program 300, in an embodiment, is capable of making an outgoing telephone call. By way of such an outgoing telephone call, the interface program 300 software may alert a user to an upcoming appointment, an urgent email, etc. Also, once the telephone call to the user has been established and the alert has been conveyed, the user could continue querying the interface program 300 for additional information to perform additional tasks.

Another embodiment involving outbound calling relates to placing and connecting telephone calls on behalf of the user by way of “phone bridging.” With telephone bridging, a user instructs the interface program 300 to place and connect an outgoing call. As a remote-access feature, telephone bridging could benefit a user who is, for example, traveling or commuting. Alternatively, a user may desire to have the interface program 300 telephone bridge even when the user is operating the computer 100 locally, so the user does not have to look up a number, find a telephone and dial the number. For example, a user could speak into a microphone “Call John Smith,” and the interface program 300 will automatically initiate the telephone bridging software. Thus, whether a user is operating a remote telephone or a local microphone, the interface program 300 software may provide an easy-to-use and flexible “front end” for IP telephony (e.g.,VoIP). Because telephone calls to and from the interface program 300 may use VoIP technology, long distance toll charges may be quite low, or even negligible, thereby providing a more economical means for the user to communicate with a third party. For economic reasons, a remote user may especially prefer VoIP phone bridging over direct dialing.

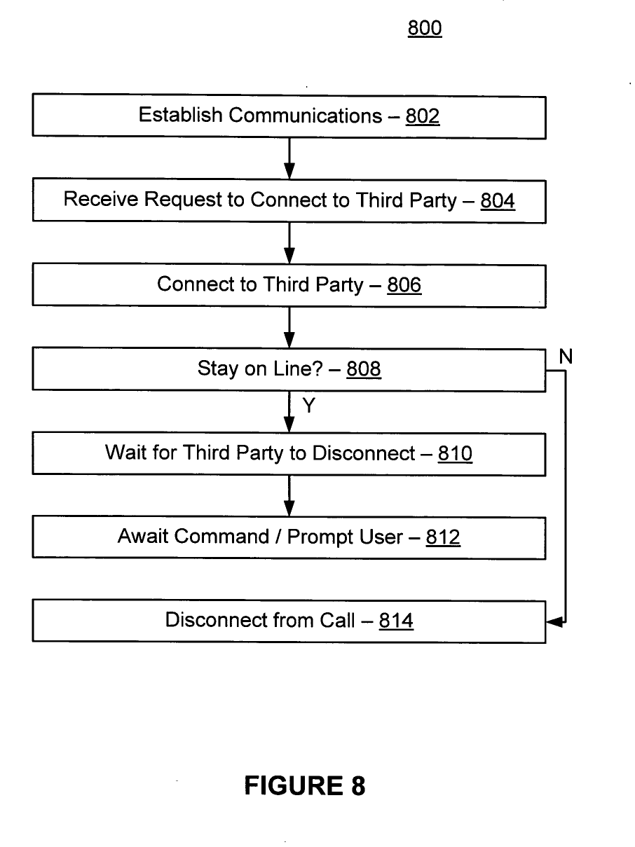

FIG. 7 is, therefore, a diagram illustrating an example software and hardware configuration in which such an embodiment may be implemented using VoIP. Thus, in an embodiment a remote user 710 communicates with the interface program by way of SIP service provider 712 A. If the remote user 710 desires to communicate with a third party, the interface program 300 communicates with SIP service provider 712 B, which in turn communicates with the third party 714. A method of establishing such communication is discussed below in connection with FIG. 8. If the user directs the interface program 300 to disconnect, the SIP service providers 712 A-B communicate with each other to continue the conversation between the user and the third party. It will be appreciated that SIP provider 712 A and 712 B may be the same provider, or even one and the same VoIP server.

FIG. 8 is a flowchart illustrating an example method 800 of connecting a user to a third party according to an embodiment of the invention. Prior to step 802, the interface program 300 may be operating in a default mode or the like, whereby it is able to accept a communications attempt from a user. At step 802, communications with a user are established. It will be appreciated that such communications may be by way of any communications channel, such as those discussed above. As part of establishing communications with a user, the interface program may switch to an appropriate hardware input and output (e.g., Virtual Audio Cable audio device with a softphone such as X-Lite) and the correct user profile for such remote devices, as was discussed above in connection with FIG. 3. The user and interface program 300 may thus communicate and the user may instruct the interface program 300 to perform desired tasks.

At step 804, a request to connect the user to a third party is received. Such a request may also include a request from the user for the interface program to disconnect from the call once the user and third party are connected, rather than to remain conferenced. In an alternate embodiment, the interface program may be directed to remain on the line. Likewise, the interface program 300 may prompt the user for such information. In an alternate embodiment, the interface program 300 may have a user profile that has a default setting or the like that indicates whether the interface program should disconnect or remain on the line. It will be appreciated that having the interface program 300 remain on the line enables the user to perform additional tasks upon the completion of the call; however, having the interface program 300 disconnect may improve signal quality between the user and the third party. In an embodiment where the user does not wish the interface program 300 to remain connected, the interface program 300 may instruct a softphone or the like to transfer the incoming call to an outgoing number. Thus, the two parties are connected directly at a SIP bridge without the interface program 300 in the middle. Furthermore, it will be appreciated that one or both SIP providers could be instructed (for example, via a command from the softphone to a SIP bridge) to host the conference, thus potentially improving connection quality while maintaining connections with all parties, including interface program 300.

At step 806, the interface program 300 connects the user to the third party. As may be appreciated, the connection may be way of any of the communications channels discussed above. At step 808, a determination is made as to whether the interface program 300 should remain on the line or should disconnect. It will be appreciated that in an embodiment where the interface program 300 instructs a softphone or the like to transfer the incoming call to an outgoing number that step 808 may be optional. The determination of step 808 may be made using, for example, the request and/or profile information or the like discussed above in connection with step 804. If the determination of step 808 is that the interface program should not remain on the line, at step 814 the interface program 300 disconnects from the call, leaving the user and third party to continue their conversation.

If the determination of step 808 is that the interface program 300 is to remain on the line, then the interface program 300 may wait for the third party to disconnect. In an embodiment, the voice recognition software 310 is deactivated during the remainder of the conversation between the user and the third party so as to avoid unintentionally interrupting the conversation. Upon detecting the third party disconnecting from the call, the interface program 300 reactivates the voice recognition software 310 and at step 812 awaits a user command or prompts the user for such a command. In another embodiment, the interface program 300 remains active during the conversation, and is able to respond to the user. Such an embodiment may have interface program 300 only attempt to recognize certain key words or the like. The interface program 300, in an embodiment, may deactivate itself or return to a previous and/or default state if the user disconnects from the call. In doing so, the interface program 300 may invoke an appropriate user profile (including hardware and/or software configuration settings) for such a state, as was discussed above in connection with FIG. 3.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1. A method of enabling communications, comprising:
establishing a first communications channel with a user;
receiving an audio user request to establish a second communications channel to enable communications with a party;
recognizing the audio user request; and
establishing the second communications channel.

2. The method of claim 1, wherein the first communications channel is initiated by the user.

3. The method of claim 1, wherein establishing the first communications channel comprises determining a type of the first communications channel and setting at least one Input/Output parameter according to the type.

4. The method of claim 3, further comprising providing a spoken prompt to the user to provide a security code and receiving an input from the user.

5. The method of claim 4, wherein the input is one of a spoken response or DTMF signal.

6. The method of claim 4, further comprising determining whether the input matches the security code and terminating the first communications channel if the input is not a match.

7. The method of claim 1, wherein the first or second communications channel is by way of a Voice over Internet Protocol connection.

8. The method of claim 1, wherein the first or second communications channel uses a Session Initiation Protocol standard.

9. The method of claim 1, wherein the audio user request contains the user's voice.

10. The method of claim 1, wherein the audio user request contains information relating to the party.

11. The method of claim 10, further comprising associating the information with a telephone number of the party.

12. The method of claim 10, wherein the information relates to the second communications channel.

13. The method of claim 10, wherein said associating step uses the information to access a user profile.

14. The method of claim 1, further comprising disconnecting from the first and second communications channels once the second communications channel has been established.

15. The method of claim 14, wherein the first and second communications channels enable communication between the user and the party.

16. The method of claim 15, wherein the first and second communications channels are facilitated by at least one Session Initiation Protocol service provider.

17. The method of claim 1, further comprising entering an inactive state from an active state once the second communications channel has been established.

18. The method of claim 17, further comprising detecting the termination of the second communications channel.

19. The method of claim 18, further comprising reentering the active state.

20. The method of claim 19, wherein the audio user request is a first request, and further comprising receiving a second audio user request.

21. The method of claim 1, further comprising detecting the termination of the first communications channel and entering an inactive state.

22. The method of claim 1, wherein the audio user request contains an instruction to remain active once the second communications channel is terminated.

23. A computer-readable medium having computer-executable instructions for performing a method of connecting a telephone call, the method comprising:
establishing a first communications channel with a user;
receiving an audio user request to establish a second communications channel to enable communications with a party;
recognizing the audio user request; and
establishing the second communications channel.

24. A method of recognizing an audio request, comprising:
establishing a communications channel between a computer and a user communications device;
detecting a user input having an audio request and storing the audio request;
accessing a user profile and selecting a first grammar based on the user profile;
attempting to recognize the audio request using the first grammar, wherein the first grammar is active;
if the audio request is not recognized, deactivating the first grammar, activating a second grammar and attempting to recognize the audio request using the second grammar.

25. The method of claim 24, wherein the user profile is selected using a user characteristic.

26. The method of claim 24, further comprising updating the user profile.

27. The method of claim 26, wherein said updating step is based on the audio request.

28. The method of claim 26, wherein said updating step is based on information from an input source.

29. The method of claim 26, wherein said updating step is based on a change in available data.

30. The method of claim 25, wherein the user characteristic is a user identity.

31. The method of claim 25, wherein the user characteristic is a user communications device type.

32. The method of claim 25, wherein the user characteristic is a communications channel type.

33. The method of claim 24, wherein said establishing step comprises accessing the user profile to determine a communications channel type and setting a parameter based on the user profile.

34. The method of claim 33, wherein the parameter is an input or output setting.

35. The method of claim 33, wherein the input or output setting enables communication with the user communications device.

36. The method of claim 33, wherein the communications channel type is determined based on the user communications device.

37. The method of claim 33, wherein the parameter is set to enhance recognition of the audio request.

38. The method of claim 24, wherein the-first and second grammars are subsets of an entire vocabulary having a plurality of possible audio requests.

39. The method of claim 24, wherein recognizing the audio request comprises matching the audio request to a possible audio request contained within the first or second grammar.

40. The method of claim 24, wherein selecting the first grammar based on the user profile further comprises accessing the user profile to determine a context in which the audio input recognition is being made and selecting the user profile based on the context.

41. The method of claim 40, wherein the context relates to a user-desired task.

42. The method of claim 40, wherein the context relates to a user identity.

43. The method of claim 40, wherein the context relates to a user communications device type.

44. The method of claim 24, wherein the audio request is stored as one of a .mp3 or .wav file.

45. The method of claim 24, further comprising, if the audio request is recognized, processing the audio request.

46. The method of claim 45, further comprising deleting the stored audio request.

47. The method of claim 45, wherein processing the audio request comprises carrying out a task related to the audio request.

48. The method of claim 45, further comprising communicating with the user.

49. The method of claim 48, wherein the communication is by way of a spoken output.

50. The method of claim 24, further comprising, if the audio request is not recognized with the second grammar, deactivating the second grammar.

51. The method of claim 50, further comprising determining whether a third grammar is available and transmitting a spoken error message to the user if a third grammar is not available.

52. The method of claim 24, wherein the communication channel is a Voice over Internet Protocol connection.

53. A computer-readable medium having computer-executable instructions for recognizing an audio command, the method comprising:
establishing a communications channel between a computer and a user communications device;
detecting a user input having an audio request and storing the audio request;
accessing a user profile and selecting a first grammar based on the user profile;
attempting to recognize the audio request using the first grammar, wherein the first grammar is active;
if the audio request is not recognized, deactivating the first grammar, activating a second grammar and attempting to recognize the audio request using the second grammar.

54. A system for providing access to a computer, comprising:
a communications component for determining a type associated with a communications channel, setting at least one input/output parameter according to the channel type, and establishing the communications channel between the computer and a remote communications device,
a sound recognition component for receiving an audio input and converting the input to digital form;
a text-to-voice component for converting textual data to spoken form;
a file interface component for interacting with a file having the data stored therein; and
an interface program, wherein the interface program is adapted to receive the input by way of the communications channel, cause the sound recognition component to convert the input to determine a desired function, and cause a component to perform the desired function.

55. The system of claim 54, wherein the interface program is further adapted to cause the file interface to interact with the file according to the desired function, and cause the text-to-voice component to provide a result of the desired function in spoken form to the remote communications device.

56. The system of claim 54, wherein the communications channel is established at the remote communications device by one of: a cellular telephone, a cordless telephone, a corded telephone, a speakerphone, a second computer having telephony software, a Voice over Internet Protocol telephone, a softphone or a second computer having instant messaging software.

57. The system of claim 54, wherein the communications channel is established by way of one of: a PSTN network, a cellular network, a Voice over Internet Protocol Network, Session Initiation Protocol service provider or a radio network.

58. The system of claim 57, wherein the communications channel is established by way of a plurality of networks.

59. The system of claim 54, wherein the sound recognition component is a voice recognition module.

60. The system of claim 54, wherein the sound recognition component is a DTMF decoder.

61. The system of claim 54, wherein the sound recognition component, text-to-voice component and file interface component are application program interfaces.

62. The system of claim 54, wherein the sound recognition component, text-to-voice component and file interface component are software applications.

63. The system of claim 54, wherein the file is one of: a spreadsheet, an email server, and email client, a database, a monitor, a sensor, a word processing file, or enterprise application data.
